(19) United States
(12) Patent Application Publication
(10) Pub. No.: US 2006/0172124 A1
(43) Pub. Date: Aug. 3, 2006

(54) Rainbow rub-ons

(76) Inventor: Hok Lin Man, North Vancouver (CA)

Correspondence Address: ROYAL W. CRAIG;A PROFESSIONAL CORPORATION, SUITE 153, 10 NORTH CALVERT STREET, BALTIMORE, MD, 21202, US

(21) Appl. No.: 11/045,863

(22) Filed: Jan. 29, 2005

(51) Int. Cl. B44C 1/17

(52) U.S. Cl. 428/195.1

(57) ABSTRACT

A rainbow rub-on that is used in a manner similar to writing with carbon paper, but transfers a myriad of color and patterns in the design created by the user who writes and/or draws on the transfer sheet thereby transferring only those colors and designs from the transfer sheet that fall within the design and/or writing of the user. The process includes four distinct layers. The first, or base, layer is a polyester film with a second layer of wax printed thereon. A third layer mixture of emulsion, pigment and adhesive of different colors and designs is applied to the second layer. An optional fourth layer of wax can be applied for stronger adhesion of the writing transfer to the paper. Adjusting the thickness of the pigments in the third layer during production allows the rainbow rub-on to be reusable.

### CROSS-REFERENCE TO RELATED APPLICATIONS

The present application is related to U.S. Provisional Patent Application No. 60/540,135 for “RAINBOW RUB-ONS”; Filed: Jan. 28, 2004; Inventor: Hok Lin Man.

### BACKGROUND OF THE INVENTION

1. Field of the Invention

The present invention relates to a writing transfer film, and more particularly, to a writing transfer film comprised of multiple layers that permanently transfers colors from the film to a desired surface.

2. Description of the Background

The use of carbon paper to transfer printing from one page to another has been known for many years. Carbon paper was used extensively before the widespread use of computers, electronic word processors, and electronic copiers to create an exact copy of a document, such as a letter, agreement, etc. Generally, the user would use two pieces of paper with a piece of carbon paper layered in between. When the user typed or wrote on the top sheet of paper, the imprint of the typing or writing on the carbon paper transferred the carbon to the second sheet of paper, creating a “carbon copy”. Typically, the carbon was solid black. Because of the nature of the carbon, handling the carbon paper by the side comprised of carbon would typically cause the carbon to come off on the user's hands. Carbon paper was used as a necessity to create a duplicate and because of its intended purpose, there was no need to be creative in color or design. With the advent and widespread use of electronic word processors, copying machines, and personal computers, the need for carbon paper has been greatly diminished, if not eliminated. However, permanently transferring color, designs, and patterns from a transfer sheet to a piece of paper in a manner similar to the use of carbon paper provides the user with a panacea of colors and designs and is a major improvement to “carbon copies”. Moreover, by drawing, sketching or writing on the transfer sheet, the user is able to utilize his or own creativity to create unique designs from the transfer film. Thus, the end result is the artist's own design in tandem with the colors and designs of the rainbow rub-on.

The concept of rub-on transfers is well known. The prior art is replete with rub-on design transfers. For example, expired U.S. Pat. Nos. 3,987,225 and 4,326,005, to Reed et al., each show a dry release transfer, comprising a carrier sheet and designs on an adhesive layer. The designs are transferred by applying pressure to the back surface of the carrier sheet. Expired U.S. Pat. Nos. 4,028,165 and 4,111,734 to Rosenfeld each show a dry transfer product and process comprised of a carrier sheet or film made of polyester or the like, a transferable indicia layer, and a pressure sensitive indicia layer overlaying the indicia.

Other prior art patents show rub-on transfers in different contexts. For example, U.S. Pat. No. 6,027,263 to Tawa shows a rub-on transfer to a photograph used to edit the photograph, and U.S. Pat. No. 6,626,183 to Pietrocola, et al. shows a rub-on transfer that is applied to finger nails. However, no single prior art apparatus, or combination of two or more, anticipates or suggests a rainbow rub-on that is used in a manner similar to writing with carbon paper, where the user creates their own design and/or writing by writing and/or drawing on the colorful design on the transfer sheet thereby transferring only those colors and designs from the transfer sheet that fall within the design and/or writing of the user. Therefore, a need exists for a rainbow rub-on encompassing this combination of characteristics.

### SUMMARY OF THE INVENTION

It is, therefore, the primary object of the present invention to provide a rainbow rub-on.

Another object of the present invention is to provide a rainbow rub-on that readily transfers to a surface in the manner similar to that of carbon paper.

It is another object of the present invention to provide rainbow rub-on that is of different shapes, sizes and patterns.

It is another object of the present invention to provide a rainbow rub-on of various colors.

It is another object of the present invention to provide a rainbow rub-on that is attractive to the user.

It is another object of the present invention to provide a rainbow rub-on that is an inventive tool to create colorful writings and drawings.

It is yet another object of the present invention to provide a rainbow rub-on that is reusable.

It is still another object of the present invention to provide a rainbow rub-on that is economical to manufacture and sell.

These and other objects are accomplished by a rainbow rub-on or writing transfer film comprised of multiple layers. The base layer is transparent film: either polyester, wax paper, OPP film, or the like, which is printed with wax to form the second layer. Designs of different colors and shapes are printed on the third layer, which is a mixture of emulsion, pigment and adhesive. An optional fourth layer of wax may be used for stronger adhesion of the writing transfer to the paper. The present invention's design is simple and straightforward, and can be economically manufactured and sold. In use, the rainbow rub-on is placed face down on a desired surface (e.g., paper) and a sharp writing implement is used to draw or write on the polyester, wax paper or OPP film layer. The pressure applied to the rainbow-rub on causes the wax layer to adhere to the third layer to ultimately form a permanent colorful design mark on the desired surface in the form of the user's writing or drawing.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side perspective view of a rainbow rub-on 5 according to a first embodiment of the present invention.

FIG. 2 is a top perspective view of an exemplary rainbow rub-on 5 of FIG. 1.

FIG. 3 is a side perspective view of a rainbow rub-on 5 according to a second embodiment of the present invention.

FIG. 4 is a flow diagram of the method of manufacturing the rainbow rub-on of the present invention.

FIG. 5 is a flow diagram of the method of use and reuse of the rainbow rub-on of the present invention.

### DETAILED DESCRIPTION OF THE PREFERRED EMBODIMENTS

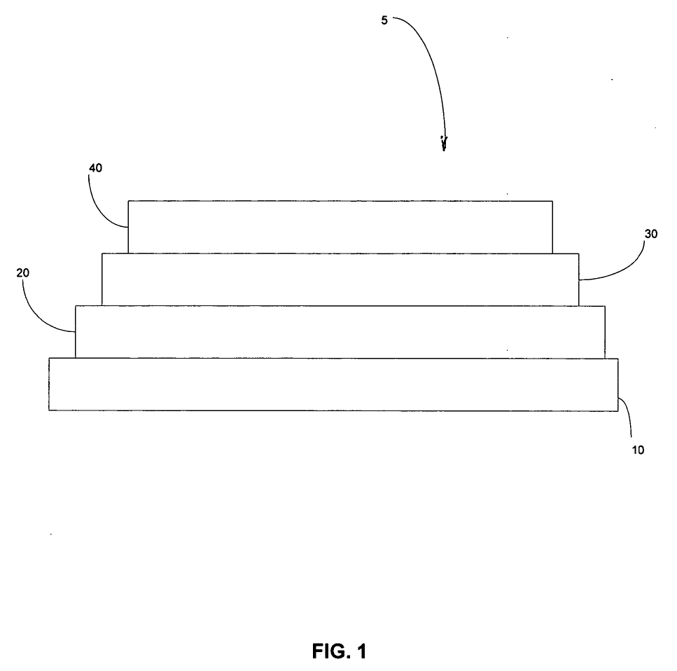

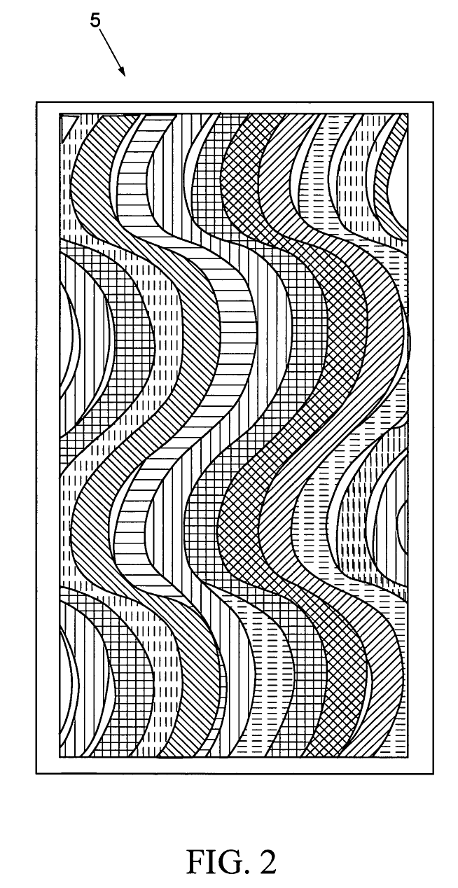

FIGS. 1 and 2 are, respectively, side and top perspective views of a rainbow rub-on 5 according to the present invention. The rainbow rub-on 5 incorporates a multi-layered, multi-material construction and generally comprises a base polyester film layer 10, a second layer of wax 20, a third layer of a mixture of emulsion, pigment, adhesive, and binder 30, and an optional fourth layer of wax 40 for stronger adhesion.

In accordance with the present invention, the base layer of film 10 may be any commercially available, conventional polyester or plastic film capable of supporting the additional steps of the manufacturing process (e.g. application of the second layer of wax 20 and the third layer of transfer color mixture of emulsion, pigment, adhesive, and binder 30).

The layer of wax 20 is emulsified and acts as an adhesive and a release base which attaches itself partially to the third layer of transfer color 30. The third layer 30 is comprised of emulsion, pigment, adhesive, and binder. The emulsion, pigment, adhesive and binder are all water-based. The pigment may be rainbow or any individual or combination color pattern.

Designs with different colors and shapes are printed in said third layer 30 either by silkscreen or offset printing. The mixture of the second layer 20 and third layer 30 ultimately forms a permanent mark or design on the desired surface of the application, without leaving traces of color on the hands or clothing. Varying the density of the pigment in the third layer 30 in the production process allows the rainbow rub-on 5 of the present invention to be either single use or reusable. Rub-ons with denser pigment can be used more than once because only a portion of the color rubs off in the first use. For example, a pigment of 5% is low and would not be reusable; however a pigment of 10% would be reusable.

A fourth layer 40 of wax may be printed on the third layer 30 to provide stronger adhesion of the writing/design transfer to the paper.

The current invention is an innovative tool for creation of colorful writings and/or designs. As any color that is used on the rainbow rub-on 5 may be transferred to the target paper, the more colorful the rub-on 5, the more colorful the end design/writing.

With respect to FIGS. 1 and 2, as is readily perceived in the foregoing description, the design of the rainbow rub-on 5 utilizes basic materials, is pleasing to the eye, is simple and straightforward, and may be economically manufactured and sold. The flexible design and construction (i.e. dimensions, configuration) of the rainbow rub-on 5 allows for its easy access and use.

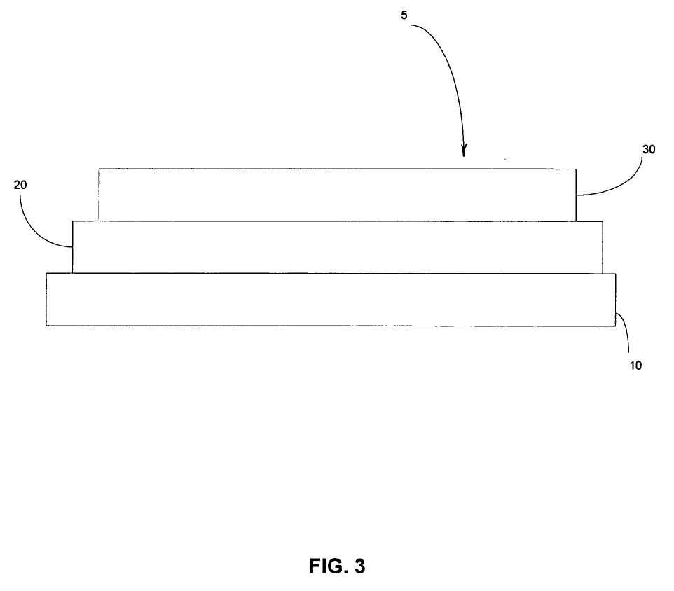

Another embodiment of the present invention is depicted in FIG. 3. In this embodiment, the fourth layer of additional wax is not applied.

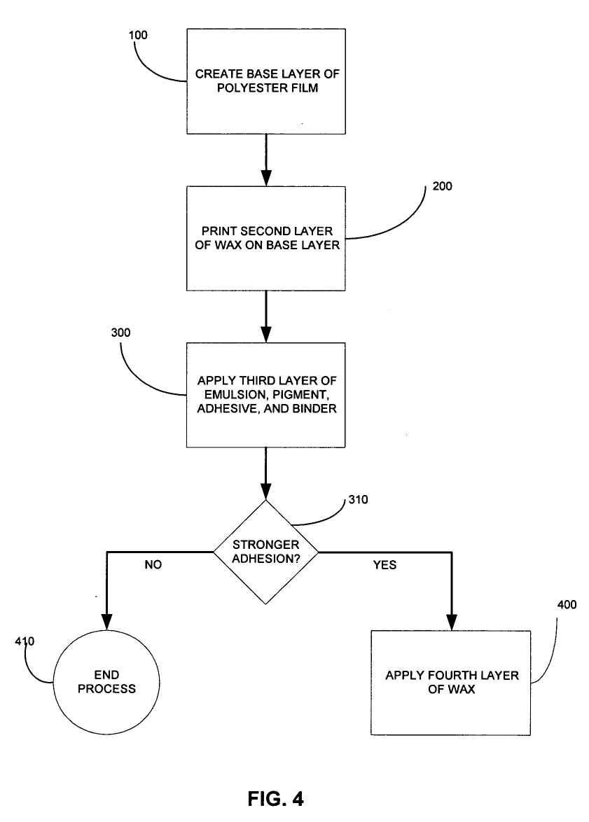

Turning now to FIG. 4, a flow diagram of the method of manufacture of the present invention is shown. At Step 100, a base layer of polyester film is created. A second layer of wax is printed on said base layer at Step 200. A third layer of emulsion, pigment, adhesive, and binder is printed on said second layer at Step 300. The current method ends at 410 unless, at 310, it is determined that a fourth layer of wax is desired for stronger adhesion. If so, a fourth layer of wax is applied at Step 400 before the process concludes at 410.

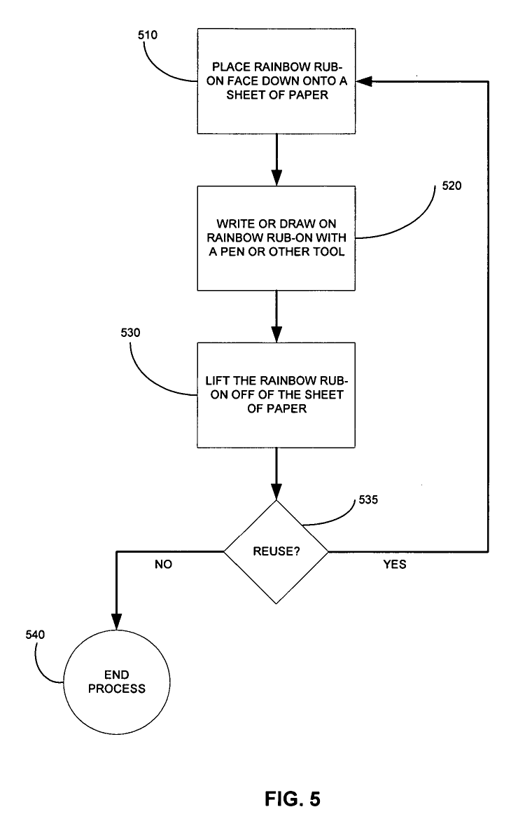

FIG. 5 is a flow diagram of the method of use of the current invention. At Step 510, the user places the rainbow rub-on 5 face down onto a sheet of paper (i.e., base layer is face up and the third or fourth layer is touching the sheet of paper). At Step 520, the user writes or draws on the rainbow rub-on 5 with a pen or other writing tool or sharp implement. Once the user writes on the rainbow rub-on 5, he or she lifts said rainbow rub-on off of the sheet of paper at Step 530. If the rainbow tub-on 5 is reusable (i.e., the third layer comprises dense pigment), the process begins again at Step 510. Otherwise, the process ends at 540.

Black or blue carbon paper has been a means for transferring printing (primarily text) from one page to another for many years. However, the rainbow rub-ons of the present invention provide a means for transferring color, designs, and patterns from a transfer sheet to a piece of paper in a manner similar to the use of carbon paper, yet provides the user with the ability to create his or her own creative writings or designs through a panacea of colors and designs.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A rainbow rub-on, comprising:
a base layer of polyester or other plastic film;
a second layer of wax on top of said base layer; and
a third layer mixture of emulsion, pigment, adhesive, and binder on top of said second layer of wax.

2. The rainbow rub-on according to claim 1 also including a fourth adhesive layer of wax on top of said third layer.

3. The rainbow rub-on according to claim 1 wherein said third layer mixture has various colors and shapes printed therein.

4. The rainbow rub-on according to claim 1 wherein the density of said pigment of said third layer mixture is increased to create a reusable rainbow rub-on and decreased to create a single use rainbow rub-on.

5. A method of manufacturing rainbow rub-ons comprising the steps of:
applying a base layer of polyester or other plastic film;
applying a second layer of wax to said layer of polyester or other plastic film; and
applying a third layer mixture of emulsion, pigment, adhesive, and binder to said second layer of wax.

6. The method of manufacturing rainbow rub-ons according to claim 5, also comprising the step of applying a fourth adhesive layer of wax to the third layer.

7. The method of manufacturing rainbow rub-ons according to claim 5, also comprising the step of increasing the density of said pigment of said third layer mixture to create a reusable rainbow rub-on.

8. The method of manufacturing rainbow rub-ons according to claim 4 wherein colors and shapes are printed in said third layer.

9. A method of using rainbow rub-ons of designs and colors comprising the steps of:
placing rainbow rub-on face down on a writing surface with base layer face up and fourth layer touching writing surface;
writing or drawing on said base layer with a pen, other writing tool, or sharp implement; and
lifting the rainbow rub-on off of the sheet of paper,
whereby the designs and colors of the rainbow rub-on are transferred to said writing surface.
